(19) United States
(12) Patent Application Publication
(10) Pub. No.: US 2024/0378893 A1
(43) Pub. Date: Nov. 14, 2024

(54) DEEP LEARNING-BASED ABNORMAL BEHAVIOR DETECTION SYSTEM THROUGH DEIDENTIFICATION DATA ANALYSIS

(71) Applicant: UNIUNI CORPORATION, Seoul (KR)

(72) Inventor: Soo Yeon HAN, Seoul (KR)

(73) Assignee: UNIUNI CORPORATION, Seoul (KR)

(21) Appl. No.: 18/684,618

(22) PCT Filed: Aug. 10, 2022
(86) PCT No.: PCT/KR2022/011935

§ 371 Date: Feb. 16, 2024

(30) Foreign Application Priority Data
Aug. 19, 2021 (KR) 10-2021-0109312

(51) Int. Cl. G06V 20/52; G06V 10/62; G06V 10/74; G06V 10/764; G06V 10/82

(52) U.S. Cl. CPC G06V 20/52; G06V 10/62; G06V 10/761; G06V 10/764; G06V 10/82

(57) ABSTRACT

The present invention relates to a deep learning-based abnormal behavior detection system which detects abnormal behavior such as installation of a hidden camera in a predetermined area such as a restroom by using de-identification data. The present invention comprises: a de-identification image information generation unit which detects a subject's behavior in a predetermined area and generates image information data in which the subject's personal information is de-identified; and an abnormal behavior discrimination unit which classifies the de-identified image information data into normal behavior data or abnormal behavior data using a learning model for abnormal behavior.

### TECHNICAL FIELD

The present invention relates to a system and a method for detecting an abnormal behavior based on deep learning.

### BACKGROUND ART

Recently, as electronic and optical technologies have developed, the performance of cameras has improved and a size of cameras has gradually reduced, resulting in frequent case of abusing the cameras for crimes. For example, a case of installing a hidden camera, which is a combination of an ultra-small camera, a microphone, and a high-performance small wireless transmitter, is installed in a place used by an unspecified number of people, and then spying on and recording voices or videos of an internal situations is rapidly increasing.

Electronic civilization, which has been developing rapidly since the 2000s, is making modern people's lives more enriched and convenient by automating various devices, whereas even electronic devices that may easily detect other people's secrets have been developed, so that there is a risk that modern people's confidential information may be exposed regardless of the intention of an information manager.

There are increasing cases of infringing on the privacy of individuals by secretly installing a camera, which is a combination of an ultra-small camera and a high-performance small wireless transmitter, in a certain place such as a public bath, toilet, changing room, hotel, office, etc., peeking at the internal situation, recording the internal situation, and using the internal situation for illegal purposes.

In particular, hidden cameras are frequently installed at entertainment establishments such as changing rooms of clothing stores, water parks, restrooms of various stores, and lodging establishments where the protection of privacy is to be observed due to the inevitable exposure of the human body, and images captured by the hidden cameras are leaked, causing enormous damage to the victims who are the targets of the crime.

Meanwhile, in order to detect the hidden cameras, it is necessary to secretly detect the hidden cameras using a separate detector. When the hidden cameras are detected using the detector, the detector has the problem of ‘post-exposure’, which secretly detects the cameras after a crime.

However, since an abnormal behavior pattern occurs in a place where privacy protection is required, if such an abnormal behavior may be detected in advance, an illegal behavior may be prevented in terms of “advanced prevention”, and a social need to detect such abnormal behavior is urgently required.

### DISCLOSURE

### Technical Problem

To solve the above problems, an object of the present invention is to provide a system for detecting an abnormal behavior capable of allowing a user to use public facilities with confidence by detecting the abnormal behavior of a subject in a predetermined area to prevent the same in advance.

The technical problems to be solved by the present invention are not limited to the above-described technical problems, and other technical problems which are not described herein will become apparent to those skilled in the art from the following description.

### Technical Solution

To solve the above-described problem, according to one embodiment of the present invention, there is provided a system for detecting an abnormal behavior based on deep learning comprising: a detection device which detects a behavior of a subject within a predetermined area to generate de-identified image information data; a deep learning server which receives the de-identified image information data from the detection device, extracts feature information from the de-identified image information data, outputs behavior prediction information reflecting a temporal change of the feature information, compares the behavior prediction information with pre-learned behavior patterns to calculate similarity, and determines whether there is an abnormal behavior by determining whether there is an abnormal behavior by determining whether the behavior prediction information belongs to a normal behavior type or an abnormal behavior type based on the similarity; and a web server which receives an abnormal behavior determination result from the deep learning server to generate a warning signal notifying that the behavior of the subject is an abnormal behavior when it is determined that the de-identified image information data belongs to the abnormal behavior type, and transmits the warning signal to a management server or a terminal.

In addition, the detection device may include a time of flight (ToF) server.

In addition, the deep learning server may include: a CNN which extracts feature information from the received de-identified image information data; an LSTM which receives the feature information from the CNN in time series to output behavior prediction information reflecting a temporal change; and a classification layer which compares the behavior prediction information received from the LSTM with learned behavior patterns, in which the classification layer may determine similarity of the behavior prediction information with respect to the learned behavior patterns based on the similarity, and determine a behavior type to which the behavior pattern determined to be most similar belongs as a behavior type of the behavior prediction information.

To solve the above-described problem, according to another embodiment of the present invention, there is provided a system for analyzing a behavior pattern by detecting a behavior of a subject within a predetermined area comprising: a reception unit which receives de-identified image information data in which the behavior of the subject is detected within the predetermined area in time series from a sensor for detecting the predetermined area; an abnormal behavior determination unit which extracts feature information from the received de-identified image information data, outputs behavior prediction information reflecting a temporal change of the feature information, compares the behavior prediction information with pre-learned behavior patterns to calculate similarity, and determines whether there is an abnormal behavior by determining whether the behavior prediction information belongs to a normal behavior type or an abnormal behavior type based on the similarity; and a transmission unit which transmits, to a management server or terminal, a signal notifying that the behavior of the subject is an abnormal behavior when the abnormal behavior determination unit determines that the de-identified image information data belongs to the abnormal behavior type.

In addition, the sensor may include a time of flight (ToF) or thermal imaging server.

In addition, the abnormal behavior determination unit may include: a CNN which extracts feature information from the received de-identified image information data; an LSTM which receives the feature information from the CNN in time series to output behavior prediction information reflecting a temporal change; and a classification layer which compares the behavior prediction information received from the LSTM with learned behavior patterns, in which the classification layer may determine similarity of the behavior prediction information with respect to the learned behavior patterns based on the similarity, and determine a behavior type to which the behavior pattern determined to be most similar belongs as a behavior type of the behavior prediction information.

In addition, the system may further include a warning notification unit which generates a warning signal such that a subject recognizes the abnormal behavior when the abnormal behavior determination unit classifies the de-identified image information data as abnormal behavior data.

In addition, the system may further include a risk notification unit which recognizes an external risk to transmit a risk signal to the management server when the abnormal behavior determination unit classifies the de-identified image information data as abnormal behavior data.

### Advantageous Effects

The present invention can prevent various crimes in advance by detecting an abnormal behavior such as secretly installing a camera in a predetermined area such as a restroom.

In addition, the present invention can fundamentally solve a personal privacy problem by acquiring a de-identified image in which personal information does not appear with respect to various behaviors in a restroom.

Meanwhile, even if the effects are not explicitly mentioned herein, it should be noted that the effects described in the following specification expected by the technical features of the present invention and the tentative effects thereof are treated as described in the specification of the present invention.

### DESCRIPTION OF DRAWINGS

FIG. 1 is a schematic view illustrating a structure of a multilayer neural network model (deep learning or deep neural network model).

FIG. 2 is a reference view for explaining a process of analyzing de-identified image information data according to one embodiment of the present invention.

FIG. 3 is a reference view schematically illustrating the entire system environment for utilizing an abnormal behavior determination result according to one embodiment of the present invention.

FIG. 4 is a block diagram schematically illustrating a structure of an abnormal behavior detection system according to one embodiment of the present information.

FIG. 5 is a configuration diagram for explaining a process of determining an abnormal behavior in the abnormal behavior detection system according to one embodiment of the present invention.

### MODE FOR INVENTION

In describing the present invention, if detailed descriptions of related known functions will be omitted if they are obvious to those skilled in the art and are determined to unnecessarily obscure the gist of the present invention.

The present invention relates to a system for detecting dangerous situations such as an abnormal behavior like installation of a hidden camera in a restroom, collapse, or falling accident by analyzing de-identified image information data based on deep learning, and is a technology for determining whether a person's behavior is an abnormal behavior by analyzing the person's behavior.

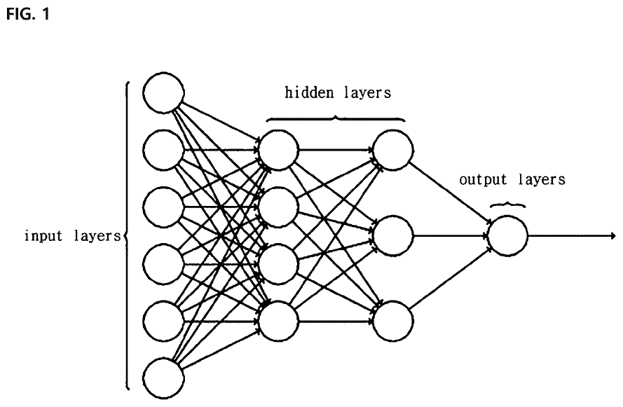

Generally, a multilayer neural network model, which means deep learning, has a structure illustrated in FIG. 1. FIG. 1 is a schematic view illustrating a structure of a multilayer neural network model (deep learning or deep neural network model). As illustrated in FIG. 1, the multilayer neural network model includes an input layer, a hidden layer, and an output layer. The input layer is composed of nodes corresponding to each input variable, and the number of nodes is the same as the number of input variables. The hidden layer serves to process a linear combination of variable values transmitted from the input layer with a non-linear function such as a sigmoid function to transmit the linear combination to the output layer or another hidden layer. Meanwhile, when a chain rule is applied to Back propagation, a vanishing gradient problem in which an error is diluted in the previous layer may occur, and a rectified linear unit (ReLU) may be used instead of the sigmoid function.

That is, the sigmoid function has a value between 0 and 1, and since gradient is continuously multiplied while passing a layer when the back propagation is performed using gradient descent, the gradient converges to 0, and as the layer increases, there may be a problem in that it does not work well. Therefore, in order to solve the problem of the sigmoid function, the ReLU may be used, in which the input value is output as 0 when the input value is less than 0 and the input value is output as it is when the input value is greater than 0. The ReLU may be partially activated by outputting 0 for an input equal to or less than 0, and since the ReLU has no vanishing of the gradient and is a linear function, there is an advantage that differential calculation is very simple.

The output layer is a node corresponding to an output variable, and an output node is generated as many as the number of classes in a classification model.

The present invention uses deep learning in a unique way to accurately analyze a person's behavior and detect an abnormal behavior within a predetermined area, thereby secretly installing a camera or detecting emergency situation. Hereinafter, an embodiment 1000 according to the present invention will be described with reference to accompanying drawings in the present application.

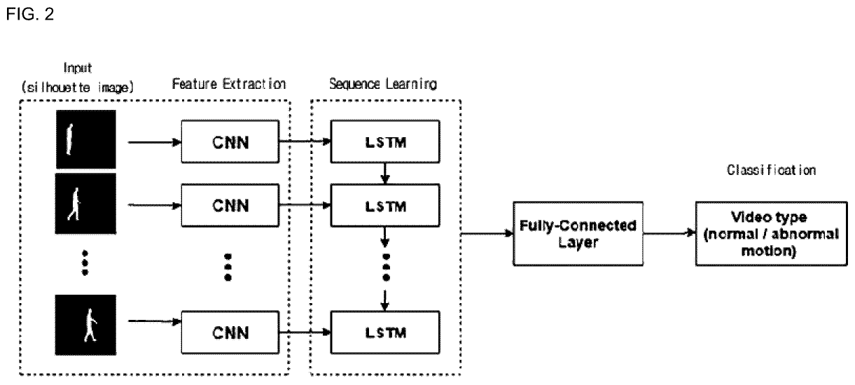

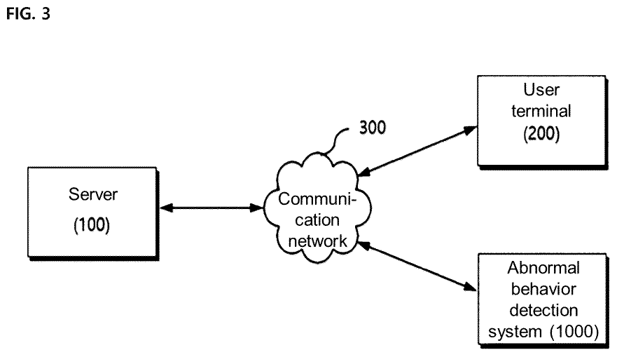

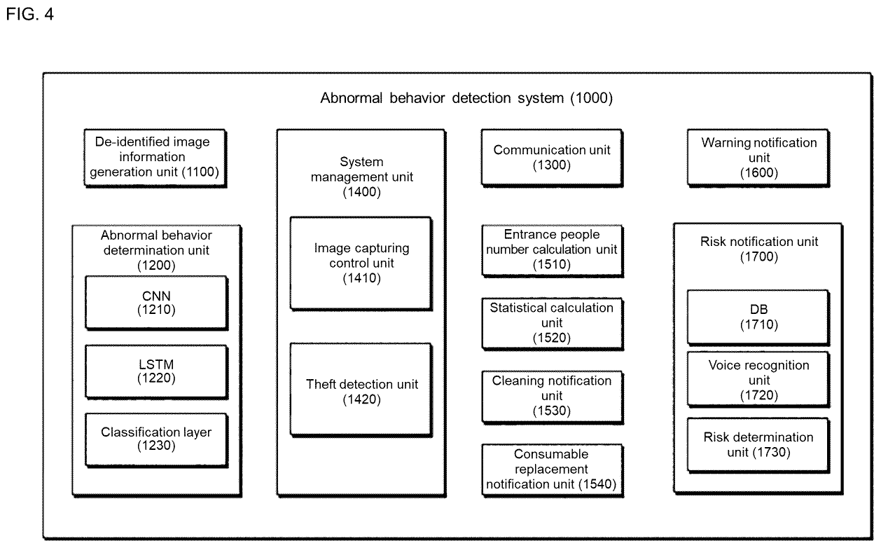

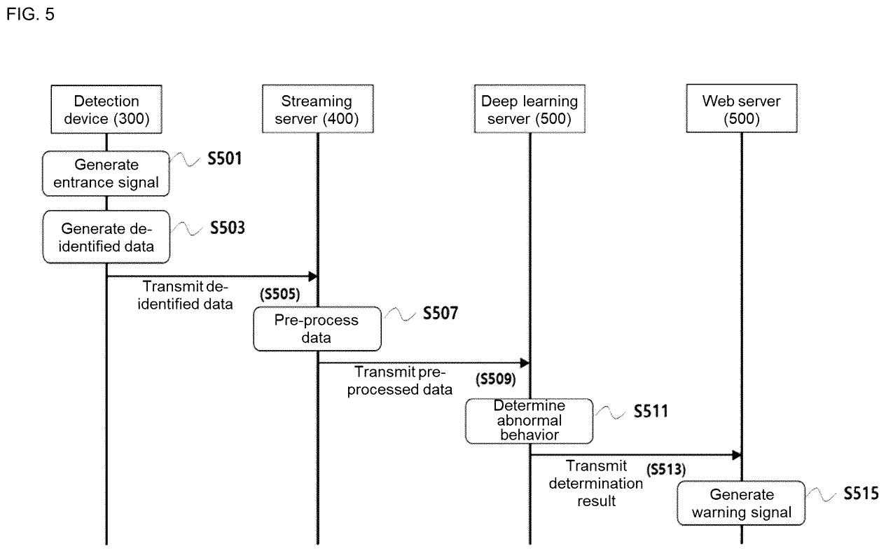

FIG. 2 is a reference view for explaining a process of analyzing de-identified image information data according to one embodiment of the present invention, FIG. 3 is a reference view schematically illustrating the entire system environment for utilizing an abnormal behavior determination result according to one embodiment of the present invention, FIG. 4 is a block diagram schematically illustrating a structure of an abnormal behavior detection system according to one embodiment of the present information, and FIG. 5 is a configuration diagram for explaining a process of determining an abnormal behavior in the abnormal behavior detection system according to one embodiment of the present invention.

In the embodiment to be described below, an abnormal behavior of installing a hidden camera inside a restroom is exemplarily described. However, the present invention is not limited to a behavior of installing the hidden camera inside the restroom, but may also generate de-identified image information about various abnormal behaviors such as a collapse accident and a falling accident of a patient or elderly person, and an unauthorized intrusion, thereby determining an abnormal behavior.

An abnormal behavior detection system 1000 that determines an abnormal behavior of a user by acquiring the abnormal behavior as de-identified image information includes a de-identified image information generation unit 1100, an abnormal behavior determination unit 1200, a communication unit 1300, a system management unit 1400, and the like.

The abnormal behavior detection system 1000 includes the de-identified image information generation unit 1100 which captures an image of a predetermined area such as a restroom. The de-identified image information generation unit 1100 senses a behavior of a subject in a predetermined area, and generates image information data obtained by de-identifying personal information such as a face of the subject, etc. In this case, the expression ‘de-identified’ means processing to make the identify of a captured person unknown Accordingly, the present invention may be smoothly operated without privacy invasion in a place such as a restroom in which personal privacy needs to be respected. In addition, the embodiment 1000 according to the present invention describes a situation in a restroom, but is not necessarily limited thereto, and may be applied to any predetermined place/space in which the personal privacy needs to be respected, such as a hospital, a sanatorium, the inside of a vehicle, a changing room, or a fitting room in a shopping mall.

The abnormal behavior detection system 1000 according to one embodiment of the present invention includes the abnormal behavior determination unit 1200 that classifies de-identified image information data as normal behavior data or abnormal behavior data using a learning model for the abnormal behavior. The abnormal behavior determination unit 1200 may accurately determine an abnormal behavior in a restroom using the learning model for an abnormal behavior generated through deep learning.

Referring to FIGS. 2 and 4, the abnormal behavior determination unit 1200 includes a CNN 1210, an LSTM 1220, and a classification layer 1230 for accurately detecting the abnormal behavior by analyzing the de-identification image information data.

The CNN 1210 is a type of multilayer feed-forward artificial neural network used to analyze a visual image, and is also referred to as a convolutional neural network. The CNN 1210 receives the de-identified image information data from the de-identified image information generation unit 1100 to extract feature information from the de-identified image information data.

The CNN 1210 transmits the extracted feature information to the LSTM 1220. The LSTM 1220 is a recurrent neural network that enables long-term dependency learning, and is also referred to as long short term memory network. The LSTM 1220 receives the feature information from the CNN 1210 in time series and outputs behavior prediction information reflecting a temporal change.

As can be seen in FIG. 2, in the embodiment 1000 according to the present invention, the feature information is extracted by the CNN 1210, and the behavior prediction information reflecting a temporal change is output by the LSTM 1220, thereby providing connectivity between frames in an image and significantly improving accuracy in detecting the abnormal behavior. The present invention may combine the CNN and the LSTM in various ways, and may also be implemented as a combination method between the CNN composed of two 2-dimensional convolutional layers and the LSTM having connectivity increased by stacking two single-layer unidirectional layers. According to one embodiment of the present invention, the CNN 1210 may extract feature information about space characteristics and characteristics of a person who is the subject, and for example, and may extract feature information from the acquired image information by predicting feature information in consideration of characteristics of a space that is a restroom and behavior characteristics of a person who takes an action in a space called a restroom.

The LSTM 1220 may output behavior prediction information by grasping the context of a behavior based on data frames that are continuous for a predetermined time. When the behavior of the subject is determined as an abnormal behavior based on the behavior prediction information output by the LSTM 1220, as illustrated in FIG. 3, the embodiment 1000 according to the present invention transmits an abnormal behavior signal to a management server 100 or a terminal 200 to notify the abnormal behavior signal. To this end, the embodiment 1000 includes the communication unit 1300 which transmits the abnormal behavior signal to at least one of the server 100 or the terminal 200 in order to notify that the behavior of the subject is an abnormal behavior when the de-identified image information data is classified as the abnormal behavior data by the abnormal behavior determination unit 1200. As illustrated in FIG. 3, the communication unit 1300 transmits the abnormal behavior signal to the management server 100 or the terminal 200 through a communication network 300. In this case, the communication network 300 means all kinds of networks such as a wide area network (WAN), a metropolitan area network (MAN), a local area network (LAN), and a personal area network (PAN).

Meanwhile, the de-identified image information generation unit 1100 may be a thermal imaging camera which detects a body temperature of the subject using an image in consideration of specificity of a space in which the privacy needs to be respected. In this case, the de-identified image information generation unit 1100 generates the thermal image information data as the de-identified image information data through capturing. Accordingly, even if the capturing is performed in the restroom by the present invention, the captured image shows only temperature data such that a captured person may not be known, thereby allowing people to use the restroom with confidence. In addition, according to another embodiment of the present invention, the de-identified image information generation unit 1100 may be a time of flight (ToF) sensor. The ToF sensor uses a technology that detects a surrounding environment or an object by measuring a time when a laser pulse is reflected and returned, and is a sensor that may perform 3D scanning or a distance of a subject by measuring a time when light irradiated from the sensor is reflected and returned to the subject such as a person. The ToF sensor may detect a distance and a depth to a subject by using a movement time of a reflected optical signal of the subject, and may more accurately recognize a motion of the subject such as a person. The ToF sensor has the advantage of being able to accurately detect an object in a short time and being hardly affected by atmospheric pressure and temperature. In addition, since a laser is used, a long distance and a range may be measured very precisely, and safety of eyes may be ensured by using low-power infrared laser light as a light source and a modulated pulse.

The abnormal behavior determination unit 1200 further includes the classification layer 1230 that compares the behavior prediction information received from the LSTM 1220 with learned behavior patterns. The learned behavior patterns are classified into a normal behavior type and an abnormal behavior type, and the abnormal behavior type may mean, for example, a behavior of installing a camera secretly in a restroom, and the normal behavior type may mean an act of doing business, an act of cleaning, an act of replacing a toilet tissue, or the like.

For example, the behavior patterns belonging to the abnormal behavior type may include an act of secretly installing a camera in an upper side and a lower side of a space separation partition in a business space (a space where a toilet is installed) in a restroom, an act of secretly installing a camera in a toilet tissue holder, etc. Here, the space separation partition means a pair of partitions installed on the left and right sides based on the toilet. Accordingly, the abnormal behavior type may be classified into five behavior patterns, which mean 1) an act of secretly installing a camera in the upper part of the left partition, 2) an act of secretly installing a camera in the lower part of the left partition, 3) an act of secretly installing a camera in the upper part of the right partition, 4) an act of secretly installing a camera in the lower part of the right partition, and 5) an act of secretly installing a camera in the toilet tissue holder. Considering the behavior patterns of the abnormal behavior type, behavior patterns belonging to the normal behavior type mean 1) an act of doing business and 2) a behavior pattern that does not belong to the abnormal behavior type.

The classification layer 1230 compares the behavior prediction information with the learned behavior patterns to determine whether the behavior prediction information belongs to any one of the normal behavior type and the abnormal behavior type. To this end, the classification layer 1230 grasps a behavior pattern that is the same as or most similar to the behavior prediction information, and classifies a behavior type to which the derived behavior pattern belongs as a behavior type of the behavior prediction information. Accordingly, the present invention determines whether the behavior of the subject captured by the de-identified image information generation unit 1100 is a normal behavior or an abnormal behavior.

FIG. 5 is a configuration diagram for explaining a process of determining an abnormal behavior in the abnormal behavior detection system according to one embodiment of the present invention.

The abnormal behavior detection system 1000 illustrated in FIG. 5 includes a detection device 300 installed at a remote place, a streaming server 400, a deep learning server 500, and a web server 600.

The detection device 300 includes the de-identified image information generation unit 1100 described in the above embodiment. The detection device may be installed in a space capable of detecting an abnormal behavior such as a restroom in the form of a module or a terminal, and may include a ToF sensor or a thermal imaging sensor for acquiring de-identified image information data, a motion sensor for detecting a user's motion, a voice recognition unit such as a microphone capable of recognizing a user's voice, a speaker capable of outputting a warning sound, a communication unit capable of communicating with an external server, etc.

As illustrated in FIG. 5, the detection device 300 detects a subject entering a predetermined area through a sensor to generate an entrance signal (S501), applies power to the de-identified image information generation unit when the entrance signal is generated to acquire image information and generate de-identified data (S503). Thereafter, the generated de-identified data is encoded and encrypted, and then transmitted to the streaming server 400.

The streaming server 400 performs predetermined pre-processing on the de-identified data received from the detection device 300, such as encryption/decryption (S507), and transmits the pre-processed data to the deep learning server 500 (S509). The streaming server 400 may perform load balancing or the like such that the deep learning server 500 may smoothly process the data when the data is transmitted from a plurality of detection devices 300.

The deep learning server 500 includes the CNN 1210, the LSTM 1220, and the classification layer 1230 described with reference to FIG. 2, and analyzes the pre-processed de-identified data received from the streaming server 400 based on deep learning to determine an abnormal behavior (S511). As described above, the deep learning server 500 determines whether the behavior prediction information belongs to the abnormal behavior type by extracting the feature information based on the de-identified data, outputting the behavior prediction information, and calculating similarity through comparison with the pre-learned behavior pattern.

The web server 600 receives an abnormal behavior determination result from the deep learning server 500 (S513), and generates a warning signal for notifying that the behavior of the subject is an abnormal behavior (S515). Thereafter, the warning signal is transmitted to the management server 100 or the terminal 200.

Meanwhile, referring to FIG. 4, the abnormal behavior detection system 1000 according to one embodiment of the present invention may further include the system management unit 1400 for managing a state of the system. The system management unit 1400 includes an image capturing control unit 1410 which detects a subject entering a set area to generate an entrance signal, and applies power to the de-identified image information generation unit 1100 when the entrance signal is generated. In normal times, the de-identified image information generation unit 1100 is maintained in a turned-off state to save electricity, and when someone enters a restroom compartment in a restroom, the image capturing control unit 1410 applies the power to the de-identified image information generation unit 1100. The image capturing control unit 1410 may be various devices that detect a behavior of a person, and may be representatively an infrared sensor, a ToF sensor, or the like.

Moreover, the system management unit 1400 includes a theft detection unit 1420 which detects vibration or inclination generated by an external impact to generate a theft signal and transmit a theft notification signal to the management server 100. The theft detection unit 1420 may include a 3-axis gyro sensor or a 3-axis acceleration sensor to detect an external impact. Accordingly, when a criminal who tries to steal a device in which the present invention is implemented or who tries to secretly install a camera tries to turn off the present invention, the theft detection unit 1420 immediately detects the criminal and transmits a theft notification signal to the management server 100, so that a manager may immediately respond to the theft of the present invention or an act of intentionally stopping the operation of the present invention.

The embodiment 1000 according to the present invention further includes an entrance person number calculation unit 1510 for detecting a person entering a restroom compartment in a restroom in real time to generate an entrance signal, and counting the generated entrance signal to derive a value of the number of people based on subjects entering a set area. The entrance person number calculation unit 1510 may be various devices that detect a person's behavior, and may be an infrared sensor or a ToF sensor such as the image capturing control unit 1410 described above. In addition, the entrance person number calculation unit 1510 may be a separate configuration from the image capturing control unit 1410, and in some cases, the entrance person number calculation unit 1510 and the image capturing control unit 1410 may be implemented as a single configuration and multi-function with the same component.

The embodiment 1000 according to the present invention further includes a statistical calculation unit 1520 which calculates a person number value per date using the person number value received from the entrance person number calculation unit 1510 and a date value of the day, and calculates a person number value per time by classifying the person number value for each date by time. The statistical calculation unit 1520 calculates entrance person statistical data based on the date and time through the number of people per date and a person number value per time of a specific date. The statistical calculation unit 1520 generates entrance person statistical data, and the number of people entering the restroom is accurately converted into data according to the date and time. The entrance person statistical data may be referred to a restroom management of the manager, and may be used for future management plans of public institutions such as local governments.

Further, the embodiment 1000 according to the present invention includes a cleaning notification unit 1530 which transmits a cleaning notification signal using the person number value received from the entrance person number calculation unit 1510. The cleaning notification unit 1530 transmits the cleaning notification signal to the management server 100 when the received person number value exceeds a preset reference person number value. Therefore, according to the present invention, it is possible to notify the manager of a time to be cleaned at an appropriate time based on the number of people who actually use the restroom.

Furthermore, the embodiment 1000 according to the present invention includes a consumable replacement notification unit 1540 which transmits a consumable replacement signal to the management server 100 by using the person number value received from the entrance person number calculation unit 1510. The consumable replacement notification unit 1540 calculates the received number of people and a preset ratio of the consumption degree per person to derive an estimated consumption value. When the estimated consumption value exceeds a reference consumption value, the consumable replacement notification unit 1540 transmits a consumable change signal to the management server 100. For example, if the number of spaces of toilet paper used by one person is 7.8 spaces, the consumable replacement notification unit 1540 derives the number of spaces of the toilet paper (estimated consumption value) used by multiplying the received number of persons by 7.8. If the derived number of toilet paper that is actually used (estimated consumption value) exceeds the number of toilet paper placed in the restroom compartment (reference consumption value), the consumable replacement notification unit 1540 transmits a toilet paper replacement signal to the server 100.

In the embodiment 1000 according to the present invention, behavior type information of the subject classified by the abnormal behavior determination unit 1200 may be transmitted to the user terminal 200, and the cleaning notification signal and the consumable replacement signal generated by the cleaning notification unit 1530 and the consumable replacement notification unit 1540 may be transmitted to the user terminal 200. The user terminal 200 displays a danger state, hygiene, and a shortage of consumables on a user interface that is designed to be recognized by the user. In addition, the user terminal 200 provides the user with a civil complaint request unit as well as a toilet state display, so that the user who recognizes the toilet state may file a civil complaint with the manager for an additional request due to a danger state that the camera is being installed secretly in the toilet or a lack of consumables. In addition, in the embodiment 1000 according to the present invention, the corresponding information is also transmitted to the management server 100 in the same manner as described above, so that the manager may recognize the restroom state, take necessary measures, and then update the restroom state. Moreover, the management server 100 transmits associated information in which the restroom information collected from the embodiment 1000 according to the present invention is associated with store information to the user terminal 200, and the user may check the restroom information for stores near the current location through the user terminal 200.

The embodiment 1000 according to the present invention includes a warning notification unit 1600 which emits the warning signal to the outside such that the subject may recognize the de-identified image information data when the de-identified image information data is classified as the abnormal behavior data in the abnormal behavior determination unit 1200. The warning notification unit 1600 emits a set warning signal when the abnormal behavior data signal is received from the abnormal behavior determination unit 1200. The warning signal may be in various forms, for example, a warning sound such as a police car siren or a red blinking form. Therefore, the present invention immediately stops the camera installation without the dispatch of the manager or security guard, thereby reliably preventing a crime in advance.

Moreover, the embodiment 1000 according to the present invention includes a risk notification unit 1700 which recognizes an external risk to transmit a risk signal to the management server 100. The risk notification unit 1700 recognizes an external situation due to occurrence of an unexpected situation such as an assault or intensity in the restroom, and immediately transmits the risk signal to the management server 100. To this end, the risk notification unit 1700 includes a database (DB) 1710 containing rescue signals and a voice recognition unit 1720 which receives a voice generated from the outside. In this case, the voice recognition unit 1720 is a device capable of recognizing the voice of a victim, and may correspond to, for example, a microphone. In addition, the risk notification unit 1700 includes a risk determination unit 1730 which compares the voice signal recognized by the voice recognition unit 1720 with the DB 1710 to transmit the risk signal to the management server 100. The risk determination unit 1730 transmits the risk signal to the management server 100 when the recognized voice signal is the same as or similar to a rescue signal stored in the DB. Accordingly, the present invention may implement a security function for proactively coping with suddenly occurring violent crimes. Alternatively, the risk determination unit 1730 compares the rescue signal learned by the learning model of the present invention with the voice signal, and transmits the risk signal to the management server 100 when the voice signal recognized from the outside is the same as or similar to the learned rescue signal. The learned rescue signal is learned in a manner similar to the learning model described above. Specifically, the CNN 1210 extracts feature information from the received voice signal, and the LSTM 1220 receives the feature information from the CNN 1210 in time series and outputs voice prediction information reflecting a temporal change. The classification layer 1230 compares the voice prediction information received from the LSTM 1220 with learned voice patterns. The learned voice patterns are classified into a general signal type and a structure signal type, and the classification layer 1230 determines similarity of voice prediction information with respect to the learned voice patterns based on the similarity, and determines the signal type to which the voice pattern determined to be most similar belongs as the signal type of the voice prediction information.

### Method for Determining Manager

The embodiment 1000 according to the present invention further includes a manager registration unit, a manager comparison unit, and a manager approval unit in preparation for a case in which a manager's act and a criminal's act performed in the restroom compartment are similar to each other. For example, the act of replacing the toilet tissue on the toilet tissue holder may have a similar pattern or a similar form to an act of secretly installing a camera on the toilet paper hanger. In this case, the present invention includes a manager registration unit, a manager comparison unit, and a manager approval unit to detect an abnormal behavior without error.

The manager registration unit stores temperature data and/or a form of the manager. In advance, the de-identified image information generation unit 1100 captures an image of the manager to generate de-identified image information data, and the CNN 1210 of the abnormal behavior determination unit extracts the feature information from the de-identified image information data for the manager to transmit the extracted feature information to the manager registration unit. Accordingly, the manager registration unit stores feature information about the manager.

The manager comparison unit compares the feature information about the manager stored in the manager registration unit with the feature information about the subject detected in real time. When both feature information are the same, the manager comparison unit transmits a manager recognition signal to the manager approval unit, and the manager approval unit transmits a stop signal to at least one of the components except for the risk notification unit 1700 of the present invention to stop the abnormal behavior detection function of the present invention. Accordingly, it is possible to always maintain a security function for unexpected crime situations of the present invention.

It is obvious to those skilled in the art that the present invention may be embodied in other specific forms without departing from features of the present invention. Therefore, the above detailed description should not be construed as limiting in all respects and should be considered as illustrative. The scope of the present invention should be determined by rational interpretation of the appended claims, and all changes within the equivalent scope of the present invention are included in the scope of the present invention.

### INDUSTRIAL APPLICABILITY

The present invention relates to a system and a method for detecting an abnormal behavior based on deep learning.

The present invention can prevent various crimes in advance by detecting an abnormal behavior such as secretly installing a camera in a predetermined area such as a restroom.

In addition, the present invention can fundamentally solve a personal privacy problem by acquiring a de-identified image in which personal information does not appear with respect to various behaviors in a restroom.

1. A system for detecting an abnormal behavior based on deep learning, the system comprising:
a detection device which detects a behavior of a subject within a predetermined area to generate de-identified image information data;
a deep learning server which receives the de-identified image information data from the detection device, extracts feature information from the de-identified image information data, outputs behavior prediction information reflecting a temporal change of the feature information, compares the behavior prediction information with pre-learned behavior patterns to calculate similarity, and determines whether there is an abnormal behavior by determining whether the behavior prediction information belongs to a normal behavior type or an abnormal behavior type based on the similarity; and
a web server which receives an abnormal behavior determination result from the deep learning server to generate a warning signal notifying that the behavior of the subject is an abnormal behavior when it is determined that the de-identified image information data belongs to the abnormal behavior type, and transmits the warning signal to a management server or a terminal.

2. The system of claim 1, wherein the detection device includes a time of flight (ToF) sensor.

3. The system of claim 1, wherein the deep learning server includes: a CNN (Convolutional Neural Network) which extracts feature information from the received de-identified image information data; an LSTM (Long Short Term Memory network) which receives the feature information from the CNN in time series to output behavior prediction information reflecting a temporal change; and
a classification layer which compares the behavior prediction information received from the LSTM with learned behavior patterns,
wherein the classification layer determines similarity of the behavior prediction information with respect to the learned behavior patterns based on the similarity, and determines a behavior type to which the behavior pattern determined to be most similar belongs as a behavior type of the behavior prediction information.

4. A system for analyzing a behavior pattern by detecting a behavior of a subject within a predetermined area, the system comprising:
a reception unit which receives de-identified image information data in which the behavior of the subject is detected within the predetermined area in time series from a sensor for detecting the predetermined area;
an abnormal behavior determination unit which extracts feature information from the received de-identified image information data, outputs behavior prediction information reflecting a temporal change of the feature information, compares the behavior prediction information with pre-learned behavior patterns to calculate similarity, and determines whether there is an abnormal behavior by determining whether the behavior prediction information belongs to a normal behavior type or an abnormal behavior type based on the similarity; and
a transmission unit which transmits, to a management server or terminal, a signal notifying that the behavior of the subject is an abnormal behavior when the abnormal behavior determination unit determines that the de-identified image information data belongs to the abnormal behavior type.

5. The system of claim 4, wherein the sensor includes a time of flight (ToF) or thermal imaging sensor.

6. The system of claim 4, wherein the abnormal behavior determination unit includes: a CNN (Convolutional Neural Network) which extracts feature information from the received de-identified image information data; an LSTM (Long Short Term Memory network) which receives the feature information from the CNN in time series to output behavior prediction information reflecting a temporal change; and
a classification layer which compares the behavior prediction information received from the LSTM with learned behavior patterns,
the classification layer determines similarity of the behavior prediction information with respect to the learned behavior patterns based on the similarity, and determines a behavior type to which the behavior pattern determined to be most similar belongs as a behavior type of the behavior prediction information.

7. The system of claim 4, further comprising a warning notification unit which generates a warning signal such that the subject recognizes the abnormal behavior when the abnormal behavior determination unit classifies the de-identified image information data as abnormal behavior data.

8. The system of claim 4, further comprising a risk notification unit which recognizes an external risk when the abnormal behavior determination unit classifies the de-identified image information data as abnormal behavior data and transmits a risk signal to the management server.
